(19) United States
(12) Patent Application Publication
(10) Pub. No.: US 2011/0030039 A1
(43) Pub. Date: Feb. 3, 2011

(54) DEVICE, METHOD AND APPARATUS FOR AUTHENTICATION ON UNTRUSTED NETWORKS VIA TRUSTED NETWORKS

(76) Inventor: Eric BILANGE, San Diego, CA (US)

Correspondence Address: QUALCOMM INCORPORATED, 5775 MOREHOUSE DR., SAN DIEGO, CA, 92121, US

(21) Appl. No.: 12/533,230

(22) Filed: Jul. 31, 2009

(51) Int. Cl. H04L 9/32

(52) U.S. Cl. 726/5

(57) ABSTRACT

The described apparatus and methods may include a security agent configured to transmit a first service request message via a trusted network, and acquire credential information via the trusted network. The security agent is further configured to transmit a second service request message via an untrusted network, wherein the second service request message comprising the credential information. The security agent is further configured to receive service via the untrusted network based on the credential information in the second service request message.

### BACKGROUND

The following description relates generally to wireless communications, and more particularly to authentication on untrusted networks via trusted networks.

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3rd Generation Partnership Project (3GPP) Long Term Evolution (LTE) systems, and orthogonal frequency division multiple access (OFDMA) systems.

Mobile devices capable of communicating with the multiple-access systems may also operate to communicate with local (e.g., personal) data networks, such as 802.11 (Wi-Fi), IEEE 802.16 (WiMAX), wireless local area network (LAN), and Bluetooth, in order to access services available on the Internet. Such networks can be referred to as “untrusted networks” as no relationship or level of trust may be required for a mobile device to access such networks.

Further, data services for mobile devices can be available through a mobile carrier to which the mobile device holds a subscription. When accessing these services, the mobile device may be required to perform the transaction for the service through the mobile carrier because of an established relationship between the mobile carrier and the service provider. In some cases, such transactions may not be permitted through a local data network, for example, a Wi-Fi hotspot, because the local data network does not authenticate the mobile device as a subscriber of the mobile carrier. As a result, the user may be required to access the services of the service provider through the mobile carrier network, which in many cases is more costly and has less bandwidth capacity than many untrusted data networks.

One technique for addressing this problem is to initialize a manual authentication procedure that requires a user of the mobile device to enter a username and password in order to access services of the service provider via the untrusted local data network. This approach, however, adds a level of complexity to the transaction process that may be too burdensome on the user.

Consequently, there exists a need for improvements in authentication on an untrusted network (e.g., local data network).

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect of the disclosure, a method for authenticating a mobile device on an untrusted network via a trusted network is provided. The method includes transmitting, by the mobile device, a first service request message via the trusted network and acquiring credential information via the trusted network. The method further includes transmitting a second service request message via the untrusted network wherein the second service request message comprises the credential information. The method further includes receiving service via the untrusted network based on the credential information in the second service request message.

According to another aspect of the disclosure, a wireless communication apparatus is provided. The apparatus includes a security agent configured to transmit a first service request message via a trusted network and acquire credential information via the trusted network. The security agent is further configured to transmit a second service request message via an untrusted network wherein the second service request message comprises the credential information. The security agent is further configured to receive service via the untrusted network based on the credential information in the second service request message.

According to a further aspect of the disclosure, another apparatus is provided. The apparatus includes means for transmitting, by a mobile device, a first service request message via a trusted network and means for acquiring credential information via the trusted network. The apparatus further includes means for transmitting a second service request message via an untrusted network wherein the second service request message comprises the credential information. The apparatus further includes means for receiving service via the untrusted network based on the credential information in the second service request message.

According to yet a further aspect of the disclosure, a computer program product including a computer-readable medium is provided. The computer-readable medium includes at least one instruction for causing a computer to transmit, by a mobile device, a first service request message via a trusted network. The computer-readable medium further includes at least one instruction for causing the computer to acquire credential information via the trusted network. Furthermore, the computer-readable medium includes at least one instruction for causing the computer to transmit a second service request message via an untrusted network wherein the second service request message includes the credential information. The computer-readable medium further includes at least one instruction for causing the computer to receive service via the untrusted network based on the credential information in the second service request message.

According to yet a further aspect of the disclosure, a wireless communications apparatus is provided. The wireless communications apparatus includes at least one processor configured to transmit, by a mobile device, a first service request message via a trusted network and acquire credential information via the trusted network. The at least one processor is further configured to transmit a second service request message via an untrusted network wherein the second service request message includes the credential information. The at least one processor is further configured to receive service via the untrusted network based on the credential information in the second service request message.

According to yet a further aspect of the disclosure, a method for authenticating a mobile device on an untrusted network via a trusted network is provided. The method includes receiving, at a service provider, a first service request message via the trusted network, and generating credential information. The method further includes transmitting the credential information via the trusted network and receiving a second service request message via the untrusted network wherein the second service request message comprises the credential information. The method further includes transmitting service via the untrusted network based on the credential information in the second service request message.

According to yet a further aspect of the disclosure, a wireless communication apparatus is provided. The wireless communication apparatus includes a service provider configured to receive a first service request message via a trusted network and generate credential information. The service provider is further configured to transmit the credential information via the trusted network and receive a second service request message via an untrusted network wherein the second service request message comprises the credential information. The service provider is further configured to transmit service via the untrusted network based on the credential information in the second service request message.

According to yet a further aspect of the disclosure, an apparatus is provided. The apparatus includes means for receiving, at a service provider, a first service request message via a trusted network and means for generating credential information. The apparatus further includes means for transmitting the credential information via the trusted network and means for receiving a second service request message via an untrusted network wherein the second service request message comprises the credential information. Further included in the apparatus is means for transmitting service via the untrusted network based on the credential information in the second service request message.

According to yet a further aspect of the disclosure, a computer program product including a computer-readable medium is provided. The computer-readable medium includes at least one instruction for causing a computer to receive, at a service provider, a first service request message via a trusted network, and at least one instruction for causing the computer to generate credential information. The computer-readable medium further includes at least one instruction for causing the computer to transmit the credential information via the trusted network and at least one instruction for causing the computer to receive a second service request message via an untrusted network wherein the second service request message comprises the credential information. Furthermore, the computer-readable medium includes at least one instruction for causing the computer to transmit service via the untrusted network based on the credential information in the second service request message.

According to yet a further aspect of the disclosure, a wireless communications apparatus is provided. The apparatus includes at least one processor configured to receive a first service request message via a trusted network and generate credential information. The at least one processor is further configured to transmit the credential information via the trusted network and receive a second service request message via an untrusted network wherein the second service request message comprises the credential information. Furthermore, the at least one processor is configured to transmit service via the untrusted network based on the credential information in the second service request message.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram illustrating an example system for utilizing a trusted network to authenticate a mobile device accessing a service provider via an untrusted network, according to one aspect;

FIG. 2 is a block diagram of an example mobile device that facilitates authentication over an untrusted network via a trusted network, according to one aspect;

FIG. 3 is a block diagram of an example system that generates credential information for use by a mobile device, according to one aspect;

FIG. 4 is a flow chart illustrating an example of a preferred network authentication process from a perspective of a mobile device, according to one aspect;

FIG. 5 is a flow chart illustrating an example of a preferred network authentication process from a perspective of a service provider, according to one aspect;

FIG. 6 is an illustration of an example system that performs authentication of a mobile device on an untrusted network via a trusted network from a perspective of a mobile device, according to one aspect; and

FIG. 7 is an illustration of an example system that performs authentication of a mobile device on an untrusted network via a trusted network from a perspective of a service provider, according to one aspect.

### DETAILED DESCRIPTION

In accordance with one or more aspects of the disclosure, a communication system may be configured to authenticate a mobile device on an untrusted network (e.g., local area network (LAN), etc.) with a trusted network (e.g., mobile carrier, etc.), such that the mobile device may receive services from a service provider through the untrusted network rather than the more costly trusted network.

In one aspect, the authentication may be accomplished by obtaining credential information from the service provider via the trusted network, and then using the credential information to receive services from the service provider across the untrusted network.

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95, and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE, and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Additionally, in the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

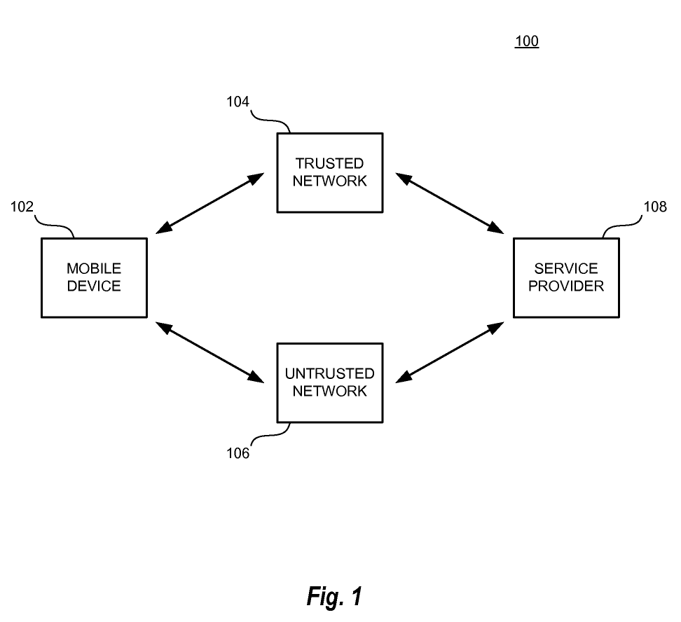

FIG. 1 is a block diagram illustrating a system 100 configured to utilize a trusted network 102 to provide a mobile device 102 with secure access to a service provider 108 via an untrusted network 106, according to one aspect. As shown in FIG. 1, the mobile device 102 may establish communications with the trusted network 104 and the untrusted network 106. The trusted and untrusted networks 104 and 106 may in turn establish communication with the service provider 108 on behalf of the mobile device 102. The mobile device 102 may be a wireless device having at least a cellular communication capability and a wireless data communication capability (e.g., Wi-Fi, WiMax, Bluetooth, etc.). The trusted network 104 may be a network of which the wireless device 102 is an authorized subscriber, such as but not limited to a cellular carrier network. The untrusted network 106 may be any network capable of providing data access to the mobile device 102, such as a local area network (LAN), Internet Protocol (IP) network, Wi-Fi, WiMax, Bluetooth, or an Internet/Web access point name (APN), etc. The service provider 108 may be a data server located on the Internet or any other network capable of providing some sort of data service (e.g., banking, merchant, etc.) to the mobile device 102.

During operation, in one aspect, when a user or operator of the mobile device 102 wishes to access a service (e.g., a weather widget, etc.) provided by the service provider 108, the user may initiate a program on the mobile device 102 to access the service. The mobile device 102 may automatically detect available networks. For example, as shown in FIG. 1, the trusted network 104 and the untrusted network 106 may be the networks available to the mobile device 102. The mobile device 102 may determine whether a status of a detected network is trusted or untrusted based on stored information indicating the current status (e.g., trusted or untrusted) of the network. Such information may, for example, be stored in a memory of the mobile device 102. If the status of the detected network is not stored in the mobile device 102, then the mobile device 102 may obtain the status of the detected network from the service provider 108 by any suitable means. Based on network availability, the mobile device 102 may then determine a route of communication with the service provider 108. The route of communication may be either via the trusted network 104 or via the untrusted network 106.

In determining the route of communication, the mobile device 102 may implement a suitable algorithm to compare various communication parameters of the trusted and untrusted networks 104 and 106, and select the network with the more preferable communication parameters. For example, if the untrusted network is less costly, has a stronger signal, and/or provides a greater quality of service than the trusted network, the mobile device may automatically decide to access the service via the untrusted network. Alternatively, the user may also manually configure the mobile device 102 to automatically select the untrusted network 106 for communication with the service provider 108. For example, if the untrusted network 106 is the user's personal wireless LAN that supports Wi-Fi connectivity, and the trusted network 104 is a cellular carrier network of which the user is a subscriber, then the user may prefer to access the service of the service provider 108 via the untrusted network 106 because of greater data transfer rates and less costly connection fees.

In one aspect, after the mobile device 102 is configured to access the service provider 108 via the untrusted network 106, the mobile device may determine whether it has acquired a session token, which includes or is otherwise referred to as credential information, from the service provider 108. The session token can be data information that identifies the mobile device 102 as a subscriber of the trusted network 104 which authorizes the mobile device 102 to access services of the service provider 108. If the mobile device 102 has not yet acquired the session token, or an already acquired session token has expired, the mobile device 102 may transmit a first request message to the service provider 108 via the trusted network 104. The first request message may be transmitted in any suitable format (e.g., Hypertext Transfer Protocol (HTTP), Transmission Control Protocol (TCP), User Datagram Protocol (UDP), etc.) to the service provider 108 requesting access to the service.

Upon receipt of the first request message, the trusted network 104 may verify that the first request message is sent from a subscriber of the trusted network 104 and that the mobile device 102 is authorized to establish a data connection with the service provider 108. Once the identity and data access privileges are verified, the trusted network 104 may modify the first request message received from the mobile device 102 with additional information such that the service provider 108 may recognize a subsequent message including the additional information as belonging to an authorized subscriber of the trusted network 104. For example, in one aspect, the trusted network 104 may modify the first request message by inserting an additional header with a Mobile Systems International Subscriber Identity Number (MSISDN) of the mobile device 102.

Once the first request message is modified, the trusted network 104 may relay the modified first request message to the service provider 108. Upon receiving the modified first request message, the service provider 108 can execute an authentication component to identify that the first request message belongs to a trusted subscriber based on the identifying information embedded in the first request message by the trusted network 104. It should be noted that in one aspect, a specific relationship may be required to exist between the trusted network 104 and the service provider 108 in order for the service provider 108 to provide authorized access information to subscribers (e.g., mobile device 102) of the trusted network 104. Such a relationship may be established by a predetermined agreement between the trusted network 104 and the service provider 108, or by some other suitable means.

According to one or more implementations, after verifying and authenticating the modified first request message, the service provider 108 may then generate a session token that includes credential information (e.g., an authentic session number) authorizing the mobile device 102 to access services of the service provider 108. According to one aspect, the credential information may be encrypted by the service provider 108 so that only the service provider 108 may later decrypt the credential information in a subsequently received message and verify the message as having been received by a device authenticated by the service provider 108. The service provider 108 may then transmit the session token to the mobile device 102 via the trusted network 104.

Upon receipt of the session token, the mobile device 102 may then store the session token in the memory of the mobile device 102, according to one example. Thereafter, the mobile device 102 may direct all subsequent communications to the service provider 108 via the untrusted network 106 instead of the trusted network 104 due to the previously established preference for the untrusted network 106. As such, the mobile device 102 may transmit a second request message to the service provider 108 via the untrusted network 106. The second request message may be transmitted in a format similar to, or different from that of the first request message. The second request message may include a copy of the credential information from the session token obtained from the service provider 108. The credential information may be included in either an additional header, an additional data packet, or any other manner appropriate for the format type (e.g., HTTP, TCP, UDP, etc.) of the second request message, or by some other suitable means. When the service provider 108 receives the second request message, it may extract the credential information from the second request message, decrypt the credential information, identify the second request message as being sent from the authorized mobile device 102, and transmit the requested service to the mobile device 102 via the untrusted network 106. It should be noted that, according to one or more aspects, the service provider 108 may continue to authenticate the mobile device 102 through the provided credential information during all subsequent sessions even if the mobile device 102 transmits the second request message via other untrusted networks and/or from a different IP address.

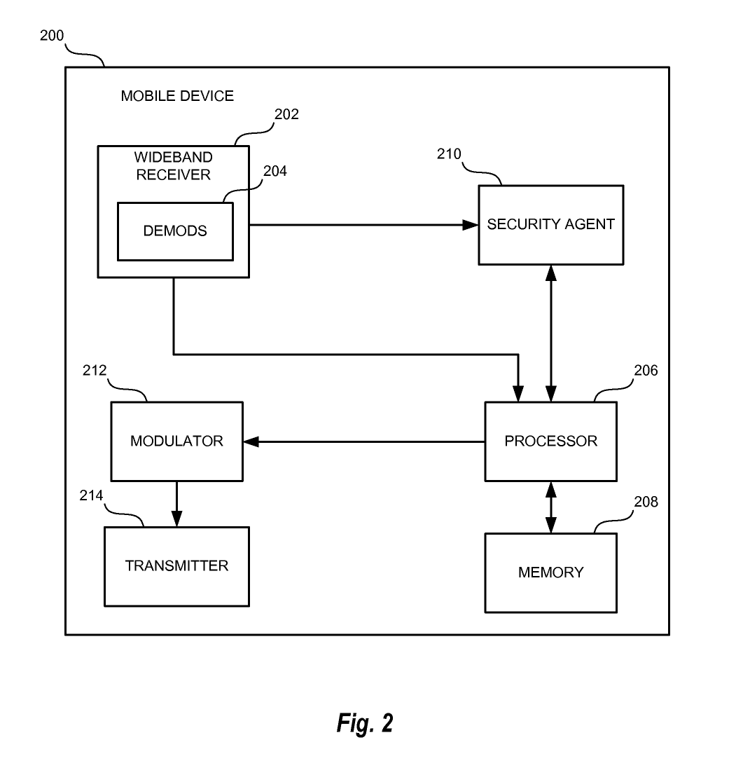

FIG. 2 is an illustration of a mobile device 200 that facilitates authentication of an untrusted network via a trusted network, according to one aspect. The mobile device 200 may correspond to the mobile device 102 shown in FIG. 1. As shown in FIG. 2, the mobile device 200 may include a receiver 202 that receives multiple signals from, for instance, one or more receive antennas (not shown), performs typical actions (e.g., filters, amplifies, downconverts, etc.) on the received signals, and digitizes the conditioned signals to obtain samples. The receiver 202 may include a plurality of demodulators 204 that can demodulate received symbols from each signal and provide them to a processor 206 for channel estimation, as described herein. The processor 206 can be a processor dedicated to analyzing information received by the receiver 202 and/or generating information for transmission by a transmitter 216, a processor that controls one or more components of mobile device 200, and/or a processor that both analyzes information received by the receiver 202, generates information for transmission by the transmitter 216, and controls one or more components of the mobile device 700.

The mobile device 200 may additionally include memory 208 that is operatively coupled to the processor 206 and that can store data to be transmitted, received data, information related to available channels, data associated with analyzed signal and/or interference strength, information related to an assigned channel, power, rate, or the like, and any other suitable information for estimating a channel and communicating via the channel. Memory 208 can additionally store protocols and/or algorithms associated with estimating and/or utilizing a channel (e.g., performance based, capacity based, etc.).

It will be appreciated that the data store (e.g., memory 208) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 208 of the subject systems and methods is intended to comprise, without being limited to, these and any other suitable types of memory.

In one aspect, the receiver 202 can further be operatively coupled to a security agent 210 that can determine and designate a preferred network based on various network parameters, control the acquisition and storage in memory 208 of one or a plurality of session tokens for communication with various service providers via untrusted networks, and direct communications through either trusted or untrusted networks by interfacing with transmitter 214 via the processor 206, as discussed with reference to FIG. 1. Mobile device 200 can further comprise a modulator 212 that modulates and transmits signals via transmitter 214 to, for instance, a base station, a web/internet access point name (APN), and another mobile devices, etc. Although depicted as being separate from the processor 206, it is to be appreciated that the security agent 210, demodulators 204, and/or modulator 212 can be part of the processor 206 or multiple processors (not shown). Furthermore, the functions of the security agent 210 may be integrated in an application layer, a data stack, an HTTP stack, at the operating system (OS) level, in an internet browser application, or in an application specific integrated circuit (ASIC).

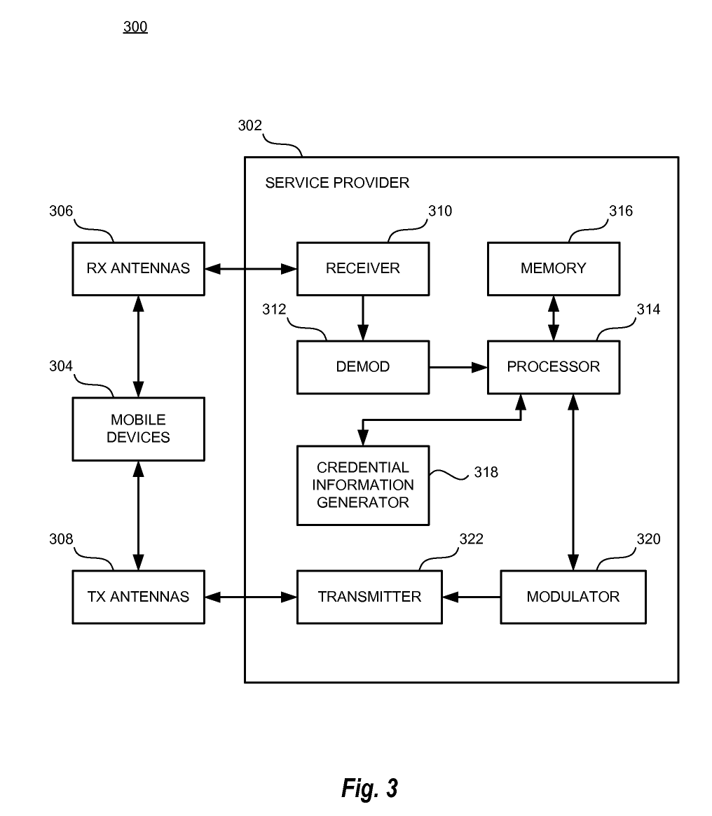

FIG. 3 is an illustration of a system 300 that generates credential information for use by a mobile device, according to one aspect. The system 300 can comprise a service provider 302 (e.g., access point, femtocell, etc.) with a receiver 310 that receives signal(s) from one or more mobile devices 304 via trusted and/or untrusted networks (not shown) through a plurality of receive antennas 306, and a transmitter 324 that transmits to the one or more mobile devices 304 via the trusted and/or untrusted networks through a transmit antenna 308. Receiver 310 can receive information from receive antennas 306 and is operatively associated with a demodulator 312 that demodulates received information. Demodulated symbols are analyzed by a processor 314 that can perform some or all functions (e.g., verification and authentication of the first request message) for the service provider 108 described above with regard to FIG. 1, and which is coupled to a memory 316 that stores information related to estimating a signal (e.g., pilot) strength and/or interference strength, data to be transmitted to or received from mobile device(s) 304 (or a disparate base station (not shown)), and/or any other suitable information related to performing the various actions and functions set forth herein. Processor 314 can further be coupled to a credential information generator 318 that can generate credential information for use by the mobile device(s) 304.

According to an example, the service provider 302 can receive a service request message from one or more of the mobile device(s) 304. After verification and authentication of the service request message by the processor 314, the credential information generator 318 may then generate a session token that includes credential information authorizing the mobile device(s) 304 to access services of the service provider 302. The credential information generator 318 may encrypt the credential information so that only the service provider 302 may later decrypt the credential information in a subsequently received message and verify the message as having been received by a device authenticated by the service provider 302. Furthermore, although depicted as being separate from the processor 314, it is to be appreciated that the credential information generator 318, demodulator 312, and/or modulator 320 can be part of the processor 314 or multiple processors (not shown).

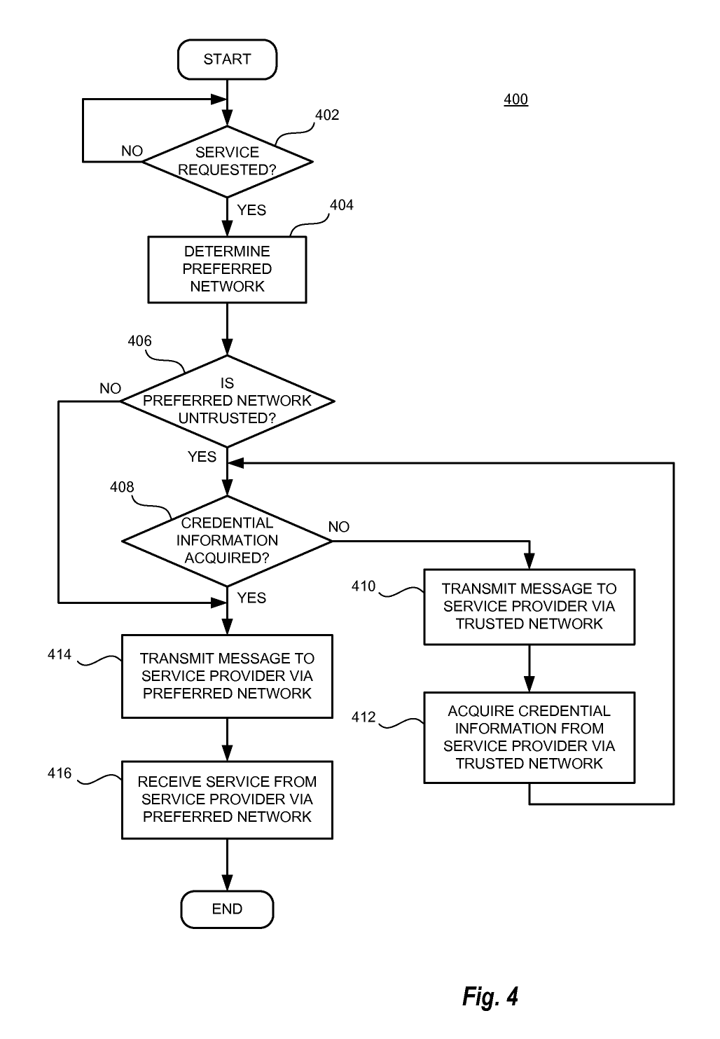

An example of a preferred network authentication process 400, which may be implemented in system 100 and mobile device 200, will now be described with reference to the flow chart illustrated in FIG. 4, according to one aspect. As shown in FIG. 4, in block 402, a determination may be made as to whether service is requested. For example, mobile device 102 may request to download a particular service (e.g., weather widget) from service provider 108. If service is requested, the process may proceed to block 404, otherwise the process may continue to check whether the mobile device 102 is requesting service.

In block 404, the process may determine a preferred network from multiple available networks, and the process may proceed to block 306. For example, security agent 210 may determine that an untrusted network, such as the untrusted network 206, has the largest bandwidth of all available networks, and, as such, designate the untrusted network 206 as the preferred network for receiving the service from the service provider 208.

In block 406, the process may determine whether the preferred network is an untrusted network. If the preferred network is untrusted, then the process may proceed to block 408, otherwise the process may proceed to block 414.

In block 408, the process may determine whether credential information for the target service provider has been acquired by the mobile device. If the credential information has been acquired, and has not yet expired, then the process may proceed to block 414, otherwise the process may proceed to block 410.

In block 410, the process may transmit a request message to the service provider via a trusted network, such as the trusted network 304, for example. The process may then proceed to block 412 where credential information may be acquired from the service provider via the trusted network. The received credential information may be generated, encrypted, and transmitted within a token similar to the session token generated by the service provider 108, authorizing the mobile device 102 to access services of the service provider 108. Thereafter, the process may proceed back to block 408.

After the process determines that credential information has been acquired in block 408, the process may proceed to block 414, where the mobile device may transmit a second request message to the service provider via the preferred network. For example, the untrusted network 106 may be the preferred network, and the second request message may include the credential information required for access to services provided by the service provider 108. The process may then proceed to block 416 where the mobile device may receive the requested service from the service provider via the preferred network, such as the untrusted network 106. For example, when the service provider 108 receives the second request message, it may identify the second request message as being sent from the authorized mobile device 102, and transmit the requested service to the mobile device 102. Thereafter, in one example, the process can end.

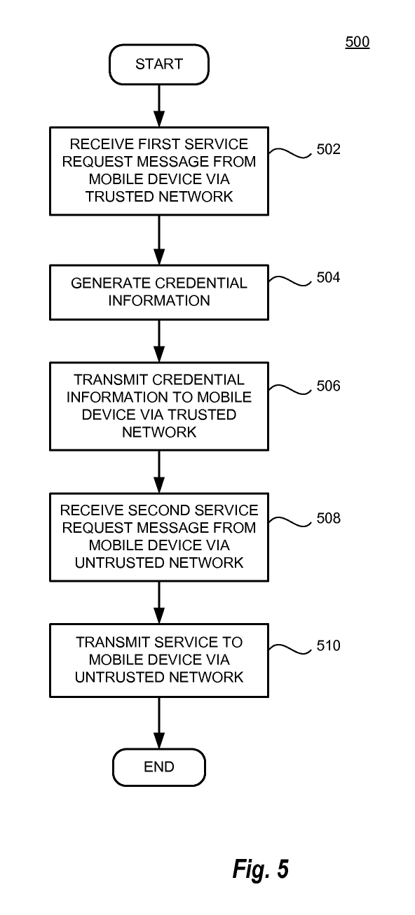

An example of a preferred network authentication process 500, which may be implemented in system 100 and service provider 302, will now be described with reference to the flow chart illustrated in FIG. 5, according to one aspect. As shown in FIG. 5, in block 502 a service provider may receive a first service request from a mobile device via a trusted network, and the process may proceed to block 504. In block 504, the service provider may generate credential information. After block 504, the process may proceed to block 506 where the service provider may transmit credential information to the mobile device via the trusted network. Thereafter, the process may proceed to block 508 where the service provider may receive a second service request from the mobile device via an untrusted network. After block 508, the process may proceed to block 510 where the service provider may transmit the requested service to the mobile device via the untrusted network. Thereafter, in on example, the process can end.

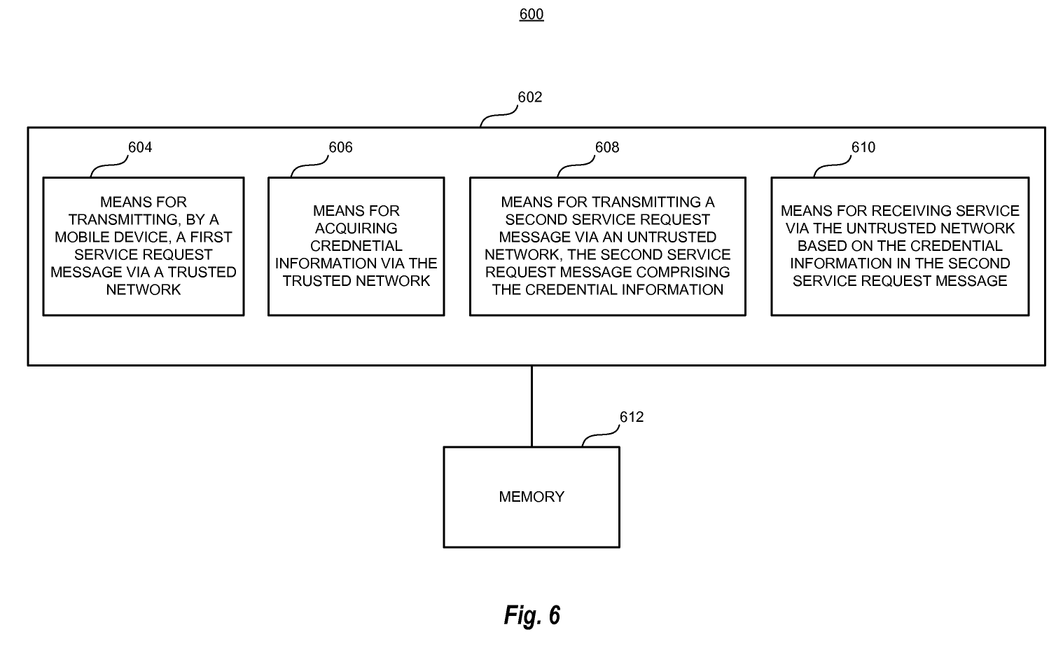

FIG. 6 is an illustration of an example system 600 that performs authentication of an untrusted network via a trusted network, according to one aspect. For example, system 600 can reside at least partially within a mobile device, etc. It is to be appreciated that system 600 is represented as including functional blocks, which can be functional blocks that represent functions implemented by a processor, software, or combination thereof (e.g., firmware). System 600 includes a logical grouping 602 of means that can act in conjunction. For instance, logical grouping 602 can include means for transmitting, by a mobile device, a first service request message via a trusted network 604 and means for acquiring credential information via the trusted network 606. The logical grouping 602 can further include means for transmitting a second service request message via an untrusted network and means for receiving service via the untrusted network based on the credential information in the second service request message 610. The second service request message can comprise the credential information 608. Additionally, system 600 can include a memory 612 that retains instructions for executing functions associated with the means 604 through 610. While shown as being external to memory 612, it is to be understood that one or more of the means 604 through 610 can exist within memory 612.

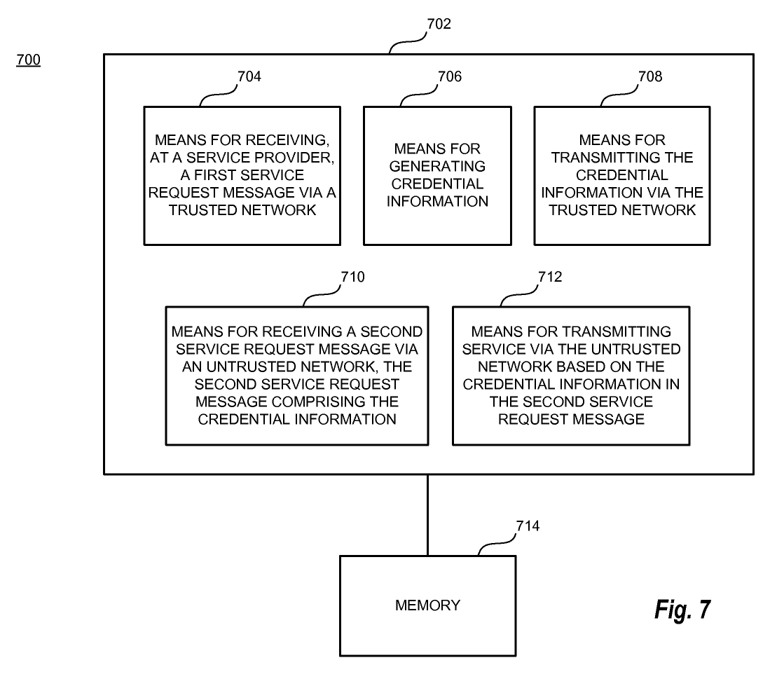

FIG. 7 is an illustration of an example system 700 that performs authentication of an untrusted network via a trusted network, according to one aspect. For example, system 700 can reside at least partially within a service provider, etc. It is to be appreciated that system 700 is represented as including functional blocks, which can be functional blocks that represent functions implemented by a processor, software, or combination thereof (e.g., firmware). System 700 includes a logical grouping 702 of means that can act in conjunction. For instance, logical grouping 702 can include means for receiving, at a service provider, a first service request message via a trusted network 704 and means for generating credential information 706. The logical grouping 702 can further include means for transmitting the credential information via the trusted network 708 and means for receiving a second service request message via an untrusted network. The second service request message can comprise the credential information 710. Furthermore, the logical grouping 702 can include means for transmitting service via the untrusted network based on the credential information in the second service request message 712. Additionally, system 700 can include a memory 714 that retains instructions for executing functions associated with the means 704 through 712. While shown as being external to memory 714, it is to be understood that one or more of the means 704 through 712 can exist within memory 714.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs usually reproduce data optically with lasers. Combinations of the above should also be included within the scope of computer-readable media.

While the foregoing disclosure discusses illustrative aspects and/or implementations, it should be noted that various changes and modifications could be made herein without departing from the scope of the described aspects and/or implementations as defined by the appended claims. Furthermore, although elements of the described aspects and/or aspects may be described or claimed in the singular, the plural is contemplated unless limitation to the singular is explicitly stated. Additionally, all or a portion of any aspect and/or implementation may be utilized with all or a portion of any other aspect and/or embodiment, unless stated otherwise.

What is claimed is:

1. A method for authenticating a mobile device on an untrusted network via a trusted network, the method comprising:
transmitting, by the mobile device, a first service request message via the trusted network;
acquiring credential information via the trusted network;
transmitting a second service request message via the untrusted network, the second service request message comprising the credential information; and
receiving service via the untrusted network based on the credential information in the second service request message.

2. The method of claim 1, wherein acquiring the credential information further comprises receiving the credential information generated by a service provider.

3. The method of claim 1, further comprising determining a route of communication by comparing communication parameters of the trusted network and the untrusted network, and designating the network with the more preferable communication parameters as the preferred route of communication.

4. The method of claim 1, wherein transmitting the second service request message further comprises inserting the credential information in a header of the second service request message.

5. The method of claim 1, wherein acquiring the credential information further comprises receiving, via the trusted network, encrypted credential information encrypted at a service provider.

6. The method of claim 5, wherein transmitting the second service request message further comprises transmitting the encrypted credential information for decrypting and authentication of the credential information at the service provider.

7. The method of claim 1, wherein transmitting the first service request message further comprises transmitting the first service request message to a service provider via a respective trusted network having a predetermined service relationship with the service provider.

8. The method of claim 1, wherein transmitting the first service request message further comprises transmitting the first service request message via a mobile carrier network.

9. The method of claim 1, wherein transmitting the second service request message further comprises transmitting the second service request message via a local area network (LAN).

10. A wireless communication apparatus, comprising:
a security agent configured to:
transmit a first service request message via a trusted network;
acquire credential information via the trusted network;
transmit a second service request message via an untrusted network, the second service request message comprising the credential information; and
receive service via the untrusted network based on the credential information in the second service request message.

11. The wireless communication apparatus of claim 10, wherein the credential information is generated by a service provider.

12. The wireless communication apparatus of claim 10, wherein the security agent is further configured to determine a route of communication by comparing communication parameters of the trusted network and the untrusted network, and to designate the network with the more preferable communication parameters as the preferred route of communication.

13. The wireless communication apparatus of claim 10, wherein the second service request message includes a header comprising the credential information.

14. The wireless communication apparatus of claim 10, wherein the received credential information is encrypted at a service provider.

15. The wireless communication apparatus of claim 10, wherein the security agent is further configured to transmit the first service request message to a service provider via a respective trusted network having a predetermined service relationship with the service provider.

16. The wireless communication apparatus of claim 10, wherein the security agent is further configured to transmit the first service request message via a mobile carrier network.

17. The wireless communication apparatus of claim 10, wherein the security agent is further configured to transmit the second service request message via a local area network (LAN).

18. An apparatus comprising:
means for transmitting, by a mobile device, a first service request message via a trusted network;
means for acquiring credential information via the trusted network;
means for transmitting a second service request message via an untrusted network, the second service request message comprising the credential information; and
means for receiving service via the untrusted network based on the credential information in the second service request message.

19. A computer program product, comprising:
a computer-readable medium comprising:
at least one instruction for causing a computer to transmit, by a mobile device, a first service request message via a trusted network;
at least one instruction for causing the computer to acquire credential information via the trusted network;
at least one instruction for causing the computer to transmit a second service request message via an untrusted network, the second service request message comprising the credential information; and
at least one instruction for causing the computer to receive service via the untrusted network based on the credential information in the second service request message.

20. A wireless communications apparatus, comprising:
at least one processor configured to:
transmit, by a mobile device, a first service request message via a trusted network;
acquire credential information via the trusted network;
transmit a second service request message via an untrusted network, the second service request message comprising the credential information; and
receive service via the untrusted network based on the credential information in the second service request message.

21. A method for authenticating a mobile device on an untrusted network via a trusted network, the method comprising:
receiving, at a service provider, a first service request message via the trusted network;
generating credential information;
transmitting the credential information via the trusted network;
receiving a second service request message via the untrusted network, the second service request message comprising the credential information; and
transmitting service via the untrusted network based on the credential information in the second service request message.

22. The method of claim 21, wherein receiving the first service request message further comprises receiving the first service request message modified at the trusted network such that the first service request message is designated as having been transmitted by an authentic subscriber of the trusted network.

23. The method of claim 21, wherein generating the credential information further comprises encrypting the credential information.

24. The method of claim 23, wherein receiving the second service request message further comprises extracting the encrypted credential information from the second service request message, and decrypting the credential information.

25. The method of claim 21, wherein receiving the first service request message further comprises receiving the first service request message via a respective trusted network having a predetermined service relationship with the service provider.

26. The method of claim 21, wherein receiving the first service request message further comprises receiving the first service request message via a mobile carrier network.

27. The method of claim 21, wherein receiving the second service request message further comprises receiving the second service request message via a local area network (LAN).

28. A wireless communication apparatus, comprising:
a service provider configured to:
receive a first service request message via a trusted network;
generate credential information;
transmit the credential information via the trusted network;
receive a second service request message via an untrusted network, the second service request message comprising the credential information; and
transmit service via the untrusted network based on the credential information in the second service request message.

29. The wireless communication apparatus of claim 28, wherein the first service request message is modified at the trusted network such that the first service request message is designated as having been transmitted by an authentic subscriber of the trusted network.

30. The wireless communication apparatus of claim 28, wherein the service provider is further configured to encrypt the credential information.

31. The wireless communication apparatus of claim 30, wherein the service provider is further configured to extract the encrypted credential information from the second service request message, and decrypt the credential information.

32. The wireless communication apparatus of claim 28, wherein the first service request message is received via a respective trusted network having a predetermined service relationship with the service provider.

33. The wireless communication apparatus of claim 28, wherein the first service request message is received via a mobile carrier network.

34. The wireless communication apparatus of claim 28, wherein the second service request message is received via a local area network (LAN).

35. An apparatus comprising:
means for receiving, at a service provider, a first service request message via a trusted network;
means for generating credential information;
means for transmitting the credential information via the trusted network;
means for receiving a second service request message via an untrusted network, the second service request message comprising the credential information; and
means for transmitting service via the untrusted network based on the credential information in the second service request message.

36. A computer program product, comprising:
a computer-readable medium comprising:
at least one instruction for causing a computer to receive, at a service provider, a first service request message via a trusted network;
at least one instruction for causing a computer to generating credential information;
at least one instruction for causing the computer to transmit the credential information via the trusted network;
at least one instruction for causing the computer to receive a second service request message via an untrusted network, the second service request message comprising the credential information; and
at least one instruction for causing the computer to transmit service via the untrusted network based on the credential information in the second service request message.

37. A wireless communications apparatus, comprising:
at least one processor configured to:
receive a first service request message via a trusted network;
generate credential information;
transmit the credential information via the trusted network;
receive a second service request message via an untrusted network, the second service request message comprising the credential information; and
transmit service via the untrusted network based on the credential information in the second service request message.
